(19) United States
(12) Patent Application Publication
(10) Pub. No.: US 2003/0186814 A1
(43) Pub. Date: Oct. 2, 2003

(54) Enhanced herbicide composition

(75) Inventors: F. Paul Silverman, Highland Park, IL (US); Peter D. Petracek, Grayslake, IL (US); Zhiguo Ju, Grayslake, IL (US); Daniel F. Heiman, Libertyville, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Valent BioSciences Corporation

(21) Appl. No.: 10/324,978

(22) Filed: Dec. 19, 2002

Related U.S. Application Data
(60) Provisional application No. 60/369,198, filed on Apr. 1, 2002.

(51) Int. Cl. A01N 57/00; A01N 37/00

(52) U.S. Cl. 504/127; 504/142

(57) ABSTRACT

An herbicide composition comprising an inhibitor of amino and biosynthesis and a salicylate or SAR inhibitor; a method of enhancing the herbicidal activity of an inhibitor of amino acid biosynthesis comprising adding to the inhibitor an effective amount of a salicylate or SAR inhibitor; and a method of controlling plant growth by applying said composition are disclosed.

### BACKGROUND OF THE INVENTION

A variety of herbicides have been used to kill unwanted plants (weeds) in crop fields or orchards. These herbicides are sprayed onto the soil (pre-emergence) or onto the plants (post-emergence).

Herbicides are expensive, and their use may result in unintentional consequences such as groundwater contamination, environmental damage, herbicide-resistant weeds, and human and mammalian health concerns.

There are many classes of herbicides that may be grouped based on their mode of action. One class of herbicides of particular interest is the inhibitors of amino acid biosynthesis which include 5-enolpyruvylshikimate 3-phosphate (EPSP) synthase inhibitors such as glyphosate and inhibitors of glutamine synthase. The different salts of glyphosate are marketed as Roundup® and Touchdown®. EPSP inhibitors act by inhibiting the biosynthesis of aromatic compounds in plants including amino acids necessary for protein synthesis. Glufosinate is an inhibitor of glutamine synthase.

The objects of the present invention are: (1) to reduce the amount of herbicide required for effective treatment, (2) to lessen the time between herbicide application and plant death, and (3) to increase the efficacy of glyphosate and its salts to prevent the development of herbicide-resistant weeds.

### SUMMARY OF THE INVENTION

The present invention is directed to a composition comprising an herbicide and a salicylate. In particular, the present invention is directed to an herbicide composition comprising an inhibitor of amino acid biosynthesis and a salicylate or SAR inhibitor.

The present invention is also directed to a method of altering the herbicidal activity of an herbicide with the presence of a salicylate or SAR inhibitor. In particular, the present invention is directed to a method of altering the herbicidal activity of an inhibitor or SAR inhibitor comprising adding to the inhibitor or SAR inhibitor, an effective amount of a salicylate. More particularly, the present invention is directed to a method of enhancing the herbicidal activity of an inhibitor or SAR inhibitor comprising adding to the inhibitor or SAR inhibitor, an effective amount of a salicylate or SAR inhibitor.

The present invention is also directed to a method of controlling plant growth comprising applying to a plant a herbicidally effective amount of a herbicidal composition comprising an herbicide and a salicylate, preferably an inhibitor or SAR inhibitor and a salicylate or SAR inhibitor.

### DETAILED DESCRIPTION OF THE INVENTION

As used herein, “salicylate” is defined as any substituted or unsubstituted benzoic acid having a hydroxyl group in the 2- or ortho-position, or a biologically acceptable salt or biological or chemical precursor thereof. Substitution on the benzoic acid includes mono-, di-, tri- or tetra-substitution in the 3-, 4-, 5- and/or 6-positions: substituents may be chosen in any combination from: lower alkyl groups of 1 to 4 carbons; an alkyl bridge containing 3 or 4 carbons attached to the benzoic acid at two adjacent points; lower alkoxy groups of from 1 to 4 carbons; the halogens fluorine, chlorine, bromine or iodine; an amino group, wherein the nitrogen may carry 0, 1, or 2 identical or different lower alkyl groups of from 1 to 4 carbons each; the nitro group; the formyl group; the acetyl group; the hydroxymethyl group; the methoxycarbonyl group; the carboxamido or sulfonamido groups wherein the nitrogen may carry 0, 1 or 2 identical or different lower alkyl substituents of from 1 to 4 carbons each; the cyano group; an alkylthio-, alkylsulfoxy-or alkylsulfonyl group, wherein the alkyl group is comprised of from 1 to 4 carbons; or a mono-, di- or trifluoromethyl group. Biologically acceptable salts include those of the common alkali metals sodium and potassium, the alkaline earths magnesium or calcium, zinc, or ammonium or simple alkylammonium cations such as mono-, di-, tri- or tetramethylammonium or other ammonium cations bearing up to 7 carbons. Biological or chemical precursors of 2-hydroxylated benzoic acid include non-hydroxylated benzoic acid and derivatives thereof having at least one ortho-position free, wherein the hydroxyl group is introduced biologically by the natural metabolic processes of the plant to which it is applied. Biological or chemical precursors of 2-hydroxylated benzoic acid also include benzoic acid compounds wherein the hydroxyl group in the 2-position is masked chemically in such a way that the masking group is labile and is easily removed once the compound has been applied to a plant, either by an enzymatic process of the plant's normal metabolism or by slow spontaneous hydrolysis. Examples of such masking groups include esters with monocarboxylic acids of from 1 to 7 carbons and trialkylsilyl ethers containing from 3 to 13 carbons. Furthermore, the term “salicylate” as used herein is understood to include mixtures of two or more of the individual pure substances defined above.

As used herein, “salicylate” is defined as any substituted or unsubstituted benzoic acid having a hydroxyl group in the 2- or ortho-position, or a biologically acceptable salt or biological or chemical precursor thereof. Substitution on the benzoic acid includes mono- di-, tri- or tetra-substitution in the 3-, 4-, 5- and/or 6-positions: substituents may be chosen in any combination from: lower alkyl groups of 1 to 4 carbons; an alkyl bridge containing 3 or 4 carbons attached to the benzoic acid at two adjacent points; lower alkoxy groups of from 1 to 4 carbons; the halogens fluorine, chlorine, bromine or iodine; an amino group, wherein the nitrogen may carry 0, 1, or 2 identical or different lower alkyl groups of from 1 to 4 carbons each; the nitro group; the formyl group; the acetyl group; the hydroxymethyl group; the methoxycarbonyl group; the carboxamido or sulfonamido groups wherein the nitrogen may carry 0, 1 or 2 identical or different lower alkyl substituents of from 1 to 4 carbons each; the cyano group; an alkylthio-, alkylsulfoxy-or alkylsulfonyl group, wherein the alkyl group is comprised of from 1 to 4 carbons; or a mono-, di- or trifluoromethyl group. Biologically acceptable salts include those of the common alkali metals sodium and potassium, the alkaline earths magnesium or calcium, zinc, or ammonium or simple alkylammonium cations such as mono-, di-, tri- or tetramethylammonium or other ammonium cations bearing up to 7 carbons. Biological or chemical precursors of 2-hydroxylated benzoic acid include non-hydroxylated benzoic acid and derivatives thereof having at least one ortho-position free, wherein the hydroxyl group is introduced biologically by the natural metabolic processes of the plant to which it is applied. Biological or chemical precursors of 2-hydroxylated benzoic acid also include benzoic acid compounds wherein the hydroxyl group in the 2-position is masked chemically in such a way that the masking group is labile and is easily removed once the compound has been applied to a plant, either by an enzymatic process of the plant's normal metabolism or by slow spontaneous hydrolysis. Examples of such masking groups include esters with monocarboxylic acids of from 1 to 7 carbons and trialkylsilyl ethers containing from 3 to 13 carbons. Furthermore, the term “salicylate” as used herein is understood to include mixtures of two or more of the individual pure substances defined above.

The composition of the present invention contains from 99.999% to 0.001% inhibitor of amino acid biosynthesis and from 99.999% to 0.001% salicylate or SAR inhibitor, preferably from 99.99% to 0.005% inhibitor or SAR inhibitor and from 99.99% to 0.005% salicylate and most preferably from 99.9% to 0.01% inhibitor or SAR inhibitor and from 99.9% to 0.01% salicylate or SAR inhibitor. In addition to the inhibitor or SAR inhibitor and salicylate or SAR inhibitor, the compositions of the present invention may contain inert solids or liquids such as water or organic solvents.

The compositions of the present invention may also be formulated as an aqueous herbicidal concentrate which is sufficiently storage stable for commercial use and which is diluted with water before use. Such concentrates have a concentration of from 100% to 0.01% of the herbicidal compositions of the present invention, preferably 50% to 0.1% and most preferably 30% to 1%.

The compositions of the present invention are dispersed or dissolved in water to a concentration of from 15% to 0.0015%, preferably 5.0% to 0.002% and most preferably 0.6% to 0.05% for application.

In an alternative embodiment of the present invention, the inhibitor or SAR inhibitor may be formulated as a concentrate and the salicylate may be formulated as a separate concentrate. The two concentrates are then mixed and diluted prior to use.

Representative EPSP inhibitors are glyphosate, N-(phosphonomethyl)glycine, and their salts. These include the monoisopropylamine salt, marketed as Roundup®, the tetramethylammonium salt, marketed as Touchdown®, and any formulation containing glyphosate or its salts alone or in combination with other herbicides. Glufosinate is an inhibitor of glutamine synthase.

Compositions of the present invention include liquid compositions, which are ready for immediate use, and solid or liquid concentrated compositions, which require dilution before use, usually with water.

The solid compositions may be in the form of granules or dusting powders wherein the active ingredient is mixed with a finely divided solid diluent (e.g. kaolin, bentonite, kieselguhr, dolomite, calcium carbonate, talc, powdered magnesia, Fuller's earth or gypsum). They may also be in the form of dispersible powders or grains, comprising a wetting agent to facilitate the dispersion of the powder or grains in liquid. Solid compositions in the form of a powder may be applied as foliar dusts.

Liquid compositions may comprise a solution, suspension or dispersion of the active ingredients in water optionally containing a surface-active agent, or may comprise a solution or dispersion of the active ingredient in a water-immiscible organic solvent which is dispersed as droplets in water. Preferred active ingredients of the composition of the present invention are water-soluble herbicides or are readily suspended in water and it is preferred to use aqueous compositions and concentrates.

The composition of the present invention may contain additional surface active agents, including for example surface active agents to increase the compatibility or stability of concentrated compositions as discussed above. Such surface-active agents may be of the cationic, anionic, or non-ionic or amphoteric type or mixtures thereof. The cationic agents are, for example, quaternary ammonium compounds (e.g. cetyltrimethylammonium bromide). Suitable anionic agents are soaps, salts of aliphatic mono esters of sulphuric acid, for example sodium lauryl sulphate; and salts of sulphonated aromatic compounds, for example sodium dodecylbenzenesulphonate, sodium, calcium, and ammonium lignosulphonate, butyinaphthalene sulphonate and a mixture of the sodium salts of diisopropyl and triisopropylnaphthalenesulphonic acid. Suitable non-ionic agents are the condensation products of ethylene oxide with fatty alcohols such as oleyl alcohol and cetyl alcohol, or with alkylphenols such as octyl- or nonyl-phenol or octylcresol. Other non-ionic agents are the partial esters derived from long chain fatty acids and hexitol anhydrides, for example sorbitan monolaurate; the condensation products of the partial ester with ethylene oxide; the lecithins; and silicone surface active agents (water soluble or dispersible surface active agents having a skeleton which comprises a siloxane chain e.g. Silwet L77®). A suitable mixture in mineral oil is ATPLUS 411F®.

Other adjuvants commonly utilized in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carrier such as ammonium nitrate, urea, and the like.

The rate of application of the composition of the present invention will depend on a number of factors including, for example, the active ingredients, the plant species whose growth is to be inhibited, the growth stage and density of the weed species, the formulation and the method of application, as for example, spraying, addition to irrigation water or other conventional means. As a general guide, however, the application rate is from 1000 to 10 liters of diluted spray solution per hectare, preferably from 200 to 100 liters per hectare.

Representative plant species that may be treated with the composition of the present invention include but are not limited to Nicotiana tabacum (tobacco), Glycine max (soybean), Setaria faberi (giant foxtail), Chenopodium album (lambsquarter), and Amaranthus retroflexus (red root pigweed), but it is not intended that the use of the compositions and methods of this invention be limited only to those species.

### EXAMPLES

In all experiments, deionized ultra-pure water was used in preparing solutions. Spray solutions were used as soon as possible after mixing.

The herbicides and spray adjuvants used in these studies included: Crop oil concentrate (COC; Orchex 796, 83%; Ag Plus300f 17%), N-(phosphonomethyl)glycine, monoisopropylamine salt (known as glyphosate), Roundup® Weed and Grass Killer Concentrate, and sodium salicylate (NaSA).

In all herbicide applications, plants were sprayed with a sufficient volume to insure good coverage, and resulted in runoff of the spray solution. COC was added to all spray solutions at a rate of 0.10% (v/v). For all treatments containing both an herbicide and a salicylate, these materials were mixed and applied in a single spray solution (commonly known as a tank mix). After spraying, plants were moved to the greenhouse and arranged in a randomized complete block experimental design. Plants were evaluated for phytotoxicity/herbicidal effects after spraying by assessing damage according to the following scale:

1=No damage

2=25% leaf area affected

3=50% leaf area affected

4=75% leaf area affected

5=100% leaf area affected (dead)

All the data were subject to an analysis of variance, and the mean separations were determined with Duncan's multiple range test at α=0.05.

The present invention may be illustrated by the following representative examples:

### Example 1

The addition of salicylate increased glyphosate activity on tobacco (Table 1). The effect was apparent 4 days after herbicide application and persisted until 11 days after application. The addition of salicylate decreased the time required for glyphosate to kill tobacco by two to three days.

TABLE 1
Effect of sodium salicylate (NaSA) on glyphosate (gluphosate = N-(phosphonomethyl) glycine,
monoisopropylamine salt) herbicidal activity against tobacco

| | Phytotoxicity | Phytotoxicity | Phytotoxicity | Phytotoxicity | Phytotoxicity |
|---|---|---|---|---|---|
| Treatment | at 4d | at 6d | at 8d | at 11d | at 14d |
| Crop Oil Concentrate, 0.1% (v/v) | 1.0 A | 1.0 A | 1.0 A | 1.0 A | 1.0 A |
| NaSA, 5 mM + COC 0.1% | 1.2 A | 1.3 AB | 1.2 A | 1.1 A | 1.1 A |
| Glyphosate, 0.2% (v/v) + COC 0.1% | 1.5 B | 2.2 CD | 3.1 D | 4.1 D | 4.9 C |
| Glyphosate 0.2% + 5 mM NaSA + COC | 1.9 C | 3.3 E | 4.1 E | 4.9 E | 5.0 C |
| 0.1% | | | | | |
| Glyphosate 0.04% + COC 0.1% | 1.2 A | 1.7 BC | 2 B | 3.1 B | 3.6 B |
| Glyphosate 0.04% + 5 mM NaSA + COC 0.1% | 1.7 BC | 2.1 C | 2.6 C | 3.5 C | 3.8 B |

Phytotoxicity rating: 1 = no damage, 2 = 25% leaf area damaged, 3 = 50% leaf area damaged, 4 = 75% leaf area damaged, 5 = 100% leaf area damaged (dead).
n = 5 plants. Mean separation by Duncan's New Multiple Range (α = 0.05).

### Example 2

The effect of salicylate on the herbicidal effect of Roundup and its active ingredient, glyphosate, is presented in Table 2. The ability of salicylate to increase Roundup activity on tobacco demonstrates that the salicylate/glyphosate effect will also work with Roundup, a commercial glyphosate formulation

TABLE 2
Effect of sodium salicylate (NaSA) on glyphosphate (glyphosphate = N-(phosphonomethyl)glycine,
monoisopropylamine salt) and Roundup herbicidal activity against tobacco

| | Phytotoxicity | Phytotoxicity | Phytotoxicity | Phytotoxicity |
|---|---|---|---|---|
| Treatment | at 2d | at 5f | at 8d | at 13d |
| Crop Oil Concentrate, 0.1% (v/v) | 1.0 A | 1.0 A | 1.0 A | 1.0 A |
| NaSA, 5 mM + COC 0.1% | 1.2 B | 1.2 A | 1.1 A | 1.0 A |
| Glyphosphate, 0.2% (v/v) + COC 0.1% | 1.3 B | 1.5 BC | 3.3 C | 4.9 B |
| Glyphosphate 0.2% + 5 mM NaSA + COC | 1.5D | 1.9 E | 3.7C | 4.9 B |
| 0.1% | | | | |
| Roundup 0.2% (v/v glyphosphate) + COC | 1.3 B | 1.5 B | 2.3 B | 4.9 B |
| 0.1% | | | | |
| Roundup 0.2% + 5 mM NaSA + COC 0.1% | 1.4 C | 1.7 CD | 3.2 C | 4.9 B |

Phytotoxicity rating: 1 = no damage, 2 = 25% leaf area damaged, 3 = 50% leaf area damaged, 4 = 75% leaf area damaged, 5 = 100% leaf area damaged (dead).
n = 5 plants. Mean separation by Duncan's New Multiple Range (α 0.05).

### Example 3

The results in Table 3 show the effect of salicylate treatment on glyphosate herbicidal activity against Giant Foxtail. This experiment demonstrates that the effect of salicylate on glyphosate activity is not limited to dicotyledenous plants.

TABLE 3
Effect of sodium salicylate (NaSA) on glyphosphate (glyphosphate = N-(phosphonomethyl)glycine,
monoisopropylamine salt) herbicidal activity against Giant Foxtail

| | | | Phytoxicity at |
|---|---|---|---|
| Treatment | Phytoxicity at 6d | Phytotoxicity at 8d | 11d |
| Crop Oil Concentrate, 0.1% (v/v) | 1.0 A | 1.0 A | 1.0 A |
| NaSA, 5 mM + COC 0.1% | 1.0 A | 1.0 A | 1.0 A |
| Glyphosphate, 0.2% (v/v) + COC 0.1% | 2.0 B | 3.8 A | 4.9 B |
| Glyphosphate 0.2% + 5 mM NaSA + COC | 2.1 BC | 4.3 C | 4.9 B |
| 0.1% | | | |

Phytoxicity rating: 1 = no damage, 2 = 25 leaf area damaged, 3 = 50% leaf area damaged, 4 = 75% leaf area damaged, 5 = 100% leaf area damaged (dead).
n = 5 palnts. Mean suppression by Duncan's New Multiple Range (α = 0.05).

### Example 4

In Table 4, the effect of sodium salicylate with glyphosate against lambsquarter is shown. These results demonstrate that salicylate may increase the efficacy of glyphosate on another dicotyldenous weed species.

TABLE 4
Effect of sodium salicylate (NaSA) on glyphosphate (glyphosphate = N-(phosphonomethyl)glycine,
monoisopropylamine salt) herbicidal activity against Lambsquarters

| | Phytotoxicity at | Phytotoxicity at | Phytotoxicity at |
|---|---|---|---|
| Treatment | 3d | 7d | 11d |
| Crop Oil Concentrate, 0.1% (v/v) | 1.0 A | 1.0 A | 1.0 A |
| NaSA, 5 mM + COC 0.1% | 1.2 AB | 1.4 AB | 1.1 A |
| Glyphosate, 0.2% (v/v) + COC 0.1% | 1.4 BC | 2.4 D | 4.0 D |
| Glyphosate 0.2% + 5 mM NaSA + COC 0.1% | 2.0 E | 4.5 F | 5.0 E |
| Glyphosate, 0.04% + COC 0.1% | 1.0 A | 1.6 BC | 2.4 C |
| Glyphosate 0.04% + 5 mM NaSA + COC 0.1% | 1.5 CD | 2.4 DE | 2.6 C |
| Glyphosate, 0.02% + COC 0.1% | 1.0 A | 1.5 ABC | 2.1 BC |
| Glyphosate 0.02% + 5 mM NaSA + COC 0.1% | 1.3 BC | 2.0 CD | 2.1 BC |
| Glyphosate, 0.004% + COC 0.1% | 1.0 A | 1.3 AB | 1.3 AB |
| Glyphosate 0.004% + 5 mM NaSA + COC 0.1% | 1.4 BC | 1.6 BC | 1.4 AB |

Phytoxicity rating: 1 = no damage, 2 = 25% leaf area damaged, 3 = 50% leaf area damaged, 4 = 75% leaf area damaged, 5 = 100% leaf area damaged (dead).
n = 6 plants. Mean separation by Duncan's New Multiple Range (α = 0.05).

### Example 5

Roundup Ready crops are tolerant to glyphosate. This tolerance is conferred by genetic modification of the crop species by the insertion of a glyphosate-insensitive EPSP synthase. Addition of salicylate did not modify the herbicidal tolerance of glyphosate on Roundup Ready soybean (Table 5). Therefore salicylate can be used to potentiate glyphosate activity on weed species without impacting Roundup Ready crops.

TABLE 5
Effect of sodium salicylate (NaSA) on glyphosate (glyphosate = N-(phosphonomethyl)Glycine,
monoisopropylamine salt) herbicidal activity against NK S2676 Soybean

| | Phytotoxicity | Phytotoxicity | Phytotoxicity | Phytotoxicity |
|---|---|---|---|---|
| Treatment | at 1d | at 4d | at 6d | at 11d |
| Crop Oil Concentrate, 0.1% (v/v) | 1.0 A | 1.0 A | 1.0 A | 1.0 A |
| NaSA, 5 mM + COC 0.1% | 1.3 AB | 1.5 B | 1.4 AB | 1.4 BC |
| Glyphosate, 0.1% (v/v) + COC 0.1% | 1.6 BC | 1.8 BC | 1.9 C | 1.9 D |
| Glyphosate 0.2% + 5 mM NaSA + COC 0.1% | 1.6 CD | 1.8 BCD | 2.1 CD | 1.9 D |

Phytotoxicity rating: 1 = no damage, 2 = 25% leaf damaged, 3 = 50% leaf area damaged, 4 = 75% leaf area damaged, 5 = 100% leaf area damaged (dead).
n = 4 plants. Mean separation by Duncan's New Multiple Range (α = 0.05).

In the claims:

1. An herbicide composition comprising an inhibitor of amino acid biosynthesis and a salicylate or SAR inducer.

2. An herbicide composition as in claim 1 wherein the inhibitor of amino acid biosynthesis is an EPSP synthase inhibitor.

3. An herbicide composition as in claim 1 wherein the inhibitor of amino acid biosynthesis is an inhibitor of glutamine synthase.

4. An herbicide composition as in claim 2 wherein the EPSP synthase inhibitor is glyphosate.

5. An herbicide composition as in claim 3 wherein the inhibitor of glutamine synthase is glufosinate.

6. An herbicide composition as in claim 1 wherein the inhibitor of amino acid biosynthesis is from 99.999% to 0.001% of the composition and salicylate or SAR inducer is from 99.999% to 0.001% of the composition.

7. An herbicide composition as in claim 1 wherein the amount of herbicide required for effective treatment is reduced.

8. An herbicide composition as in claim 1 wherein the time between herbicide application and plant death is reduced.

9. An herbicide composition as in claim 4 wherein the spectrum of glyphosate and its salts is increased and consequently the development of herbicide-resistant weeds is prevented or reduced.

10. An herbicide composition as in claim 4 wherein the efficacy of glyphosate and its salts is increased and consequently the development of herbicide-resistant weeds is prevented or reduced.

11. An herbicide composition as in claim 1 that is dissolved in water.

12. An herbicide composition as in claim 11 wherein the water is from 0.1% to 99.99% of the composition.

13. An herbicide composition as in claim 1 wherein the salicylate is salicylic acid or a biologically acceptable salt thereof.

14. An herbicide composition as in claim 1 wherein the salicylate is sodium salicylate.

15. A method of enhancing the herbicidal activity of an inhibitor of amino acid biosynthesis comprising adding to the inhibitor an effective amount of a salicylate or SAR inhibitor.

16. A method of controlling plant growth comprising applying to a plant a herbicidally effective amount of a herbicidal composition of claim 1.
